(19) United States
(12) Patent Application Publication
(10) Pub. No.: US 2009/0007608 A1
(43) Pub. Date: Jan. 8, 2009

(54) MOBILE REFRIGERATOR WITH A DOOR LOCKING SYSTEM HAVING A STRIKER CATCH

(75) Inventor: Manfred Lorek, Siegen (DE)

Correspondence Address: PEARNE & GORDON LLP, 1801 EAST 9TH STREET, SUITE 1200, CLEVELAND, OH, 44114-3108, US

(73) Assignee: Dometic GmbH, Siegen (DE)

(21) Appl. No.: 12/019,869

(22) Filed: Jan. 25, 2008

(30) Foreign Application Priority Data
Feb. 5, 2007 (DE) 20 2007 001 638.7

(51) Int. Cl. E05C 3/30; A47B 96/04

(52) U.S. Cl. 70/144; 312/405

(57) ABSTRACT

A mobile refrigerator with a refrigerator door is held magnetically against the body thereof. An additional hook lock (1 and 19) automatically engages on closing the refrigerator door and releases the refrigerator door only following the actuation of an unlocking mechanism. The unlocking mechanism disengages the hook bolt (7) from the lock striker (20), characterized in that the hook lock (1 and 19) comprises a locking member (14) by means of which the hook bolt (7) may be restrained in a disengaged position so that the refrigerator door is only held closed magnetically. The hook lock (1 and 19) is also characterized in that the locking member (14) is able to be so actuated independently of the unlocking mechanism that the hook bolt (7) is set in the disengaged position.

The subject matter of the invention is a mobile refrigerator as set forth in the preamble of claim 1 and furthermore a hook bolt lock for such a mobile refrigerator in accordance with the preamble of claim 3.

In the case of mobile refrigerators for leisure campers, caravans, boats or the like it is normal for the refrigerator door to be provided with magnetic strips all around it. In the closed state such strips pull toward corresponding metallic abutment in the refrigerator housing. They thus ensure that the refrigerator door is sealed in its engagement with the housing right the way around. This is more particularly desired in difficult conditions involved on the road, during which the mobile refrigerator is subjected to vibrations, twisting loads and acceleration, which have a tendency to disengage the refrigerator door temporarily from the body of the refrigerator.

Conventionally a refrigerator door will have a compartment in which bottles may be placed. Such bottles load the refrigerator door during travel and exert relatively heavy inertial forces thereon. Moreover, they tend, in unfavorable conditions, to pull the refrigerator door open, when the vehicle is parked on a slope, as is sometimes not to be avoided even on camping sites.

Accordingly suggestions have already been made to fit such mobile refrigerator additionally with a hook bolt which snaps home as soon as the refrigerator door is closed and holds the refrigerator door by interlocking engagement. In order to open the refrigerator door again it is firstly necessary to disengage the hook bolt. This is usually done by thrusting on a knob, which is let into the top edge of the refrigerator door, for example by way of a linkage so that the hook bolt is shifted upward and brought out of engagement with the striker (so-called unlocking mechanism). Such a hook lock ensures that the magnetic closing forces are not overridden by accident with an unintended opening of the door.

Such self-locking hook locks are employed because other additional locking means which must be mindfully operated to function, have not proved successful. For it has been found in practice that in the case of additional but not automatic locking means the user often forgets to lock them up. The refrigerator door will then open of its own accord at the next sharp corner. As a result the entire contents of the refrigerator will be tipped out as a mess in the interior of the leisure vehicle. In the special case of campers there may even be dangers, when the owner is forgetful and fails to lock the additional locking means prior to starting off. This is particularly so in the case of refrigerators mounted athwart the direction of travel in the rear part of the camper or trailer. In the case of such refrigerators there is the danger of the refrigerator door springing open when the vehicle is suddenly braked so that the contents of the refrigerator are all spilt into the driver part of the vehicle, which is normally not shut off from the living room part of the caravan.

The use of additional automatically locking bolts of known type does however lead to problems. On the one hand in the particular case of mobile homes sojourning for several weeks at a single site, it is decidedly inconvenient to grope around in the confined interior of the vehicle normally used by several persons, and only to be able to open the refrigerator door after a separate unlocking knob has been depressed, instead of just opening the refrigerator door with one hand in a single movement, as one is wont to do at home. Difficulties are entailed in such cases in the particular case of families with small children. The unlocking knob, normally placed adjacent to the top edge of the refrigerator door is often out of the reach of small children. This is more particularly the case when the refrigerator is installed with a space underneath it for storage purposes. Owing to this grown-ups will have to stand up in the course of family meals an unnecessary number of times from the table.

Accordingly it is one object of the invention to provide a mobile refrigerator which is so locked by a hook lock that on the one hand the user continuously on the road has much less chance of forgetting locking the refrigerator door as necessary during traveling while on the other hand there is a possibility of opening the mobile refrigerator during prolonged sojourns conveniently with a single movement without having to firstly unlock the door.

The object is to be achieved with the features of claim 1. The locking member restraining the hook bolt in a disengaged position and accordingly preventing engagement of the hook bolt renders it possible to permanently deactivate the hook bolt as soon as the leisure vehicle is off road at a single site and there is accordingly no necessity of securing the refrigerator door against its accidentally springing open. On the other hand the hook bolt can be rapidly and permanently activated again, when the leisure vehicle is to be on the road again.

Preferably the locking member is so fashioned that it may be operated independently of the unlocking mechanism and ideally so that the unlocking mechanism and the locking member are completely uncoupled from one another, i. e. from the unlocking mechanism because the hook bolt is held in the disengaged position and the unlocking mechanism is not forced to assume any particular position. This means not only a simplification of design. In fact, it is now also possible to ensure that user of a locking member will not make necessary any change as regards the unlocking mechanism, which has proved satisfactory.

In the prior art a wide variety of hook locks has been proposed in a quite different context. As a rule such hook locks are utilized for locking sliding windows or sliding doors in buildings.

Many of the prior art hook locks also already have a locking member in the widest sense of the term. A known locking member is in a position of holding the hook bolt in the disengaged position, when the sliding door or the sliding window is to remain free for movement in either direction, i. e. when locking of the hook lock is to be avoided as soon as the two halves of the sliding of the sliding window meet. Such locks are however relatively complex in structure. For in the case of such locks an attempt is made to so design the unlocking mechanism in any case present for disengaging the engaged hook bolt in the course of opening of the sliding door or of the sliding window that it is in a position of holding the hook bolt in the disengaged position.

Thus the French patent publication 2 131 119 discloses a hook lock for a sliding door or a sliding window, in the case of the hook bolt is held pivotally on the housing and on its rear side bears teeth. These teeth are engaged by a linearly moving rack. The rack is connected with the unlocking mechanism (for the hook bolt) as such for the hook bolt lock. Provided that the unlocking mechanism is suitably designed the rack may be locked in a position in which the hook bolt is disengaged.

The design of this lock is comparatively complex, since the hook bolt must be provided with teeth which must be either relatively accurately manufactured or must be lubricated to keep the actuating forces within limits. Furthermore in the case of this design the locking member is not able to be operated independently of the unlocking mechanism. Owing to such features the known hook lock is quite expensive to manufacture and furthermore care must be taken as regards the unlocking mechanism to ensure that the locking function of this lock may also be effective.

The Swiss patent publication CH 326464 discloses a hook lock for sliding room closure element, which is operated using an actuating rod, which shifts a four cornered thrust member to and fro. On the actuating rod there is a ledge which holds the hook bolt in the disengaged position as long as the actuating rod is restrained by the thrust member in its top position. This hook lock comprises a whole series of individual parts, is complex in structure and is correspondingly expensive. In this case as well it is not possible to use any desired sort of unlocking mechanism together with the hook lock since as regards the unlocking mechanism it is necessary to take into account the function of the lock itself.

Therefore a further aim of the invention is to provide a compactly designed hook lock comprising a bolt element and an associated striker element into which the hook bolt fits, the lock being suitable for installation as a module-like unit in a mobile refrigerator and which has an extremely simple configuration and offers the possibility of restraining the hook bolt in the disengaged position, while however representing a unit which operates substantially independently of the unlocking mechanism employed on the respective refrigerator.

This object is to be attained by the features of claim 3. The hook lock designed on these lines constitutes a compact subassembly, in the case of which all components necessary for the bolt element are held in or on the bolt housing so that only the bolt housing must be attached in order to mount the entire bolt element as a self-contained unit. As regards the locking member no particular attention need be paid to the unlocking mechanism. The bolt element fitted with the locking member is also suitable for upgrading an existing structure. Accordingly a similar hook lock not having a locking member on a refrigerator door may be replaced by it.

In accordance with an advantageous further development of the invention the locking member is a slide moving linearly in the bolt housing and which may be thrust into a first position and held therein, in which it locks the hook bolt in a disengaged position and into a second position, in which it does not curtail the function of the hook bolt. A slide, which only requires a linear movement in order to be thrust from the first position into the second position s quite simple, only needs a minimum of guiding and support means on the bolt housing and only occupies a small amount of space.

Another advantageous further development is such that the slide runs on that end side of the bolt housing which has the window for the passage of the hook-like locking postion, the slide here being guided in a groove on the outer side of the bolt housing. Accordingly the support and guidance of the slide is simple. This is because on one side the slide runs in this design on the end wall, present in any case, of the bolt housing. Accordingly on this end side of the bolt housing only a sort of extension must be provided, which holds the slide in contact with the guiding wall of the bolt housing. Furthermore the slide may then in this manner also be actuated even when the bolt housing, as is normally the case, is inside the refrigerator door on its two narrow longitudinal sides and at its narrow end side facing away from the locking portion and accordingly is not accessible.

In an advantageous fashion the groove surrounds the slide only in a portion thereof, ideally for less than 50% (of the main surface, i. e. the surface of the largest side of the slide). In other words, the groove only surrounds the slide so that the possible extreme positions of the slide and the functions performed by the slide in these positions are to be seen at a glimpse from the outside. In this case the slide is preferably molded using a plastic material having a color conspicuously different from that of the bolt housing. These measures are advantageous because leisure vehicles have quite long service lives and may often change owners many times. In this respect steps are frequently not taken to ensure that each new owner really gets the instruction manuals for the various pieces of equipment, to put him in the picture about its functions. It is therefore reasonable to design the slide so that each new owner is able to intuitively get a grasp of the functions of the slide and how it is to be handled.

By way of conclusion it is furthermore to be noted that the invention may be employed with advantage as well for mobile refrigerators in buses or modern trucks for long distance use, since the conditions here are similar to those in leisure vehicle. Moreover, the hook lock in accordance with the invention may also be employed in principle for other pieces of equipment, involving similar requirements to those of mobile refrigerators, in leisure vehicles such as oven doors held shut by a spring but benefiting from an additional lock.

Furthermore advantages and effects of the invention will be understood from the description of an embodiment in the following account.

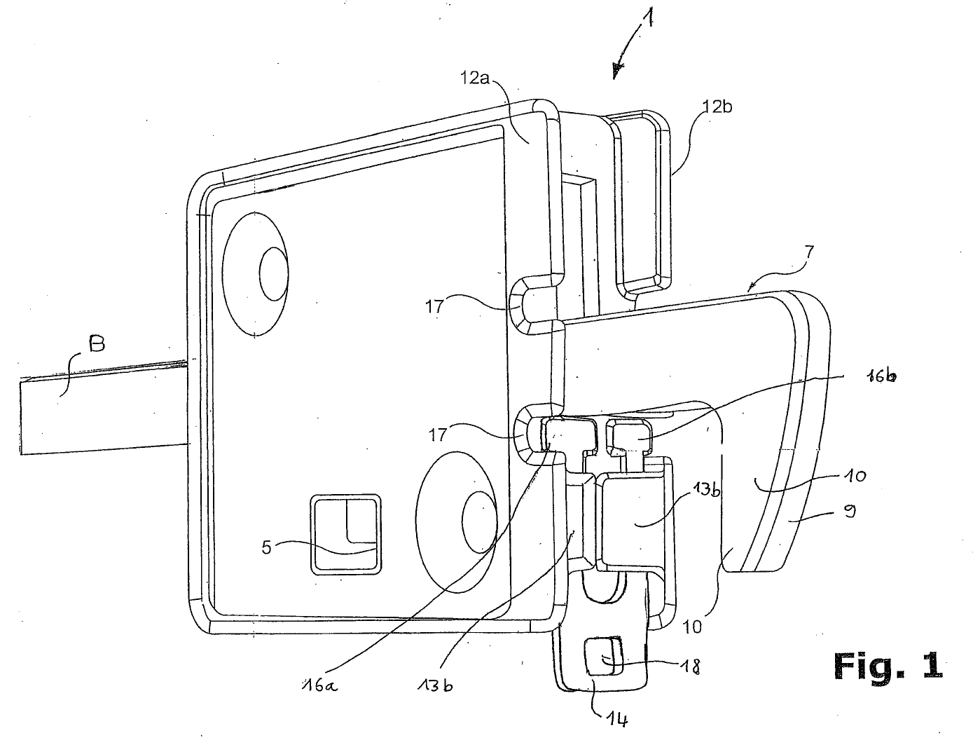

FIG. 1 shows a working example of the hook lock in accordance with the invention in the case of which the slide is located in the deactivated position, i. e. in its second position, in which it does not limit the function of the hook bolt.

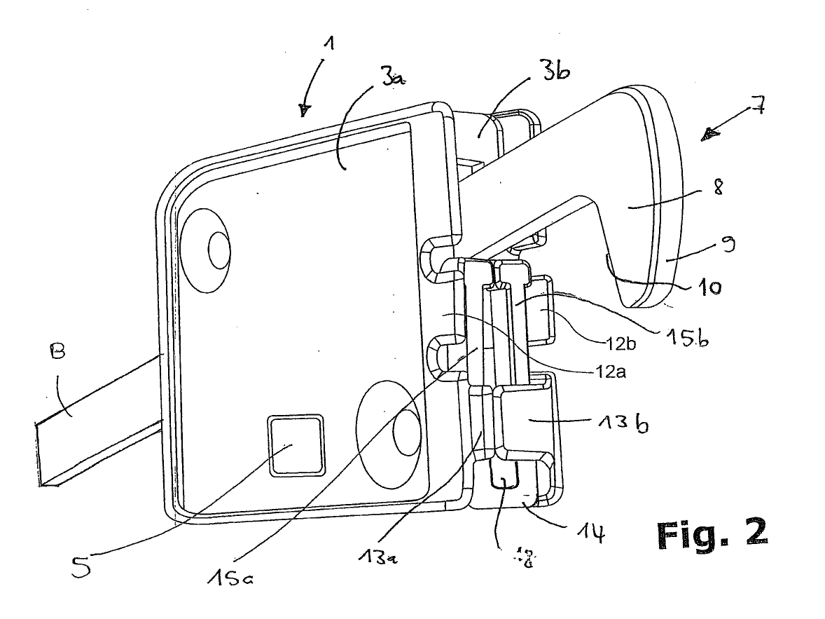

FIG. 2 shows the working embodiment of FIG. 1 at an instant in which the slide is just short of its first position in which it acts as a catch and holds the hook bolt in its disengaged position.

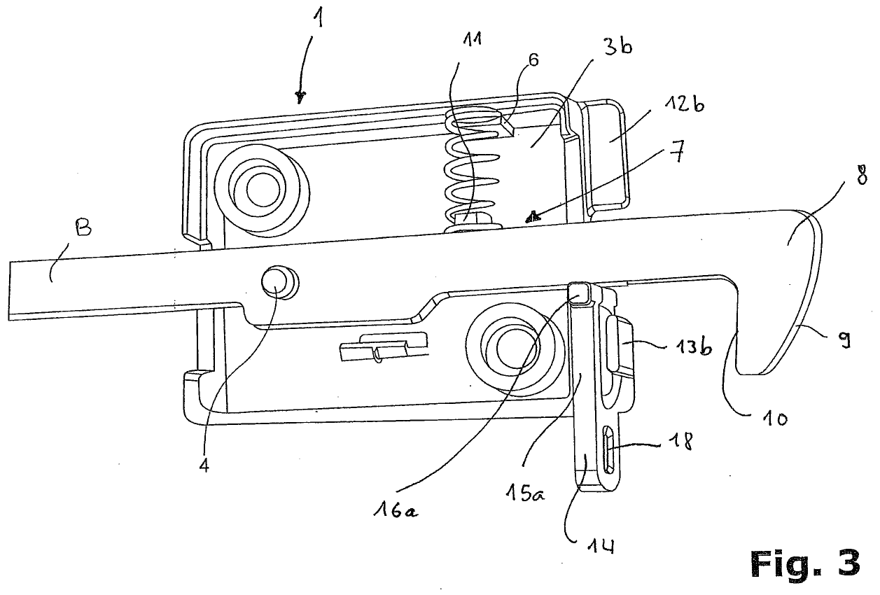

FIG. 3 shows the working embodiment of FIGS. 1 and 2 in a condition in which the housing shell facing the reader is dismounted so that parts in the inner bolt housing may be seen.

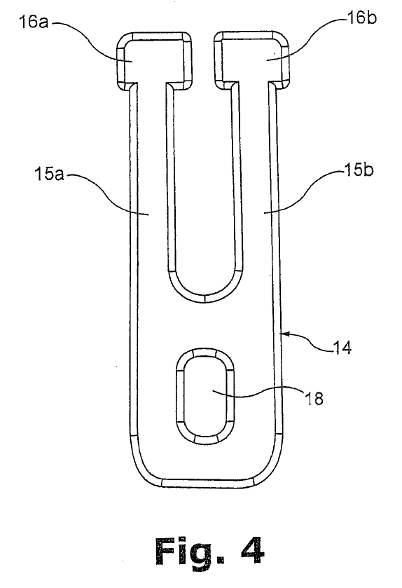

FIG. 4 shows the slide of the working example in a separate view.

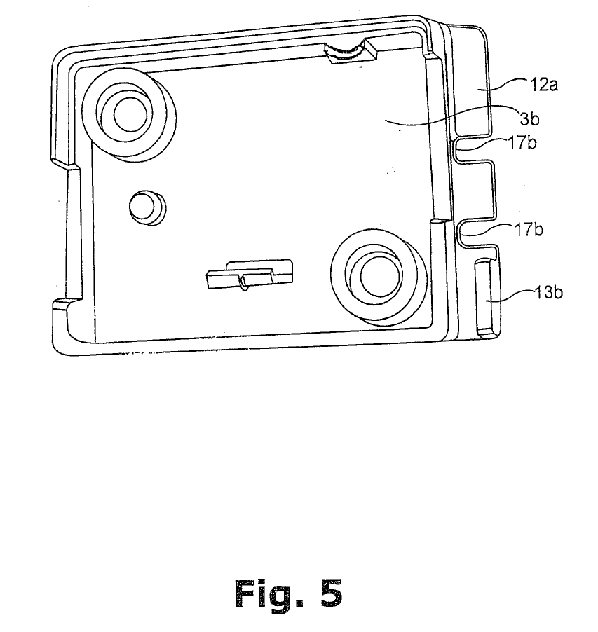

FIG. 5 shows the striker element belonging thereto.

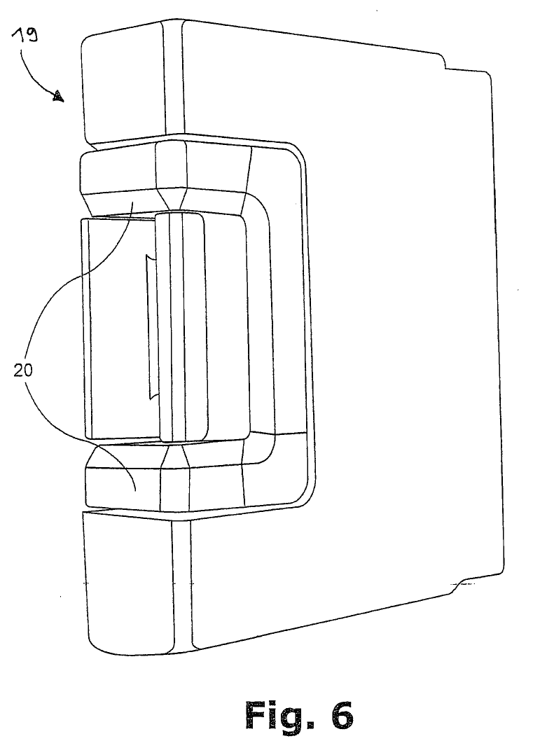

FIG. 6 shows the respective striker element with the lock striker drawn outward.

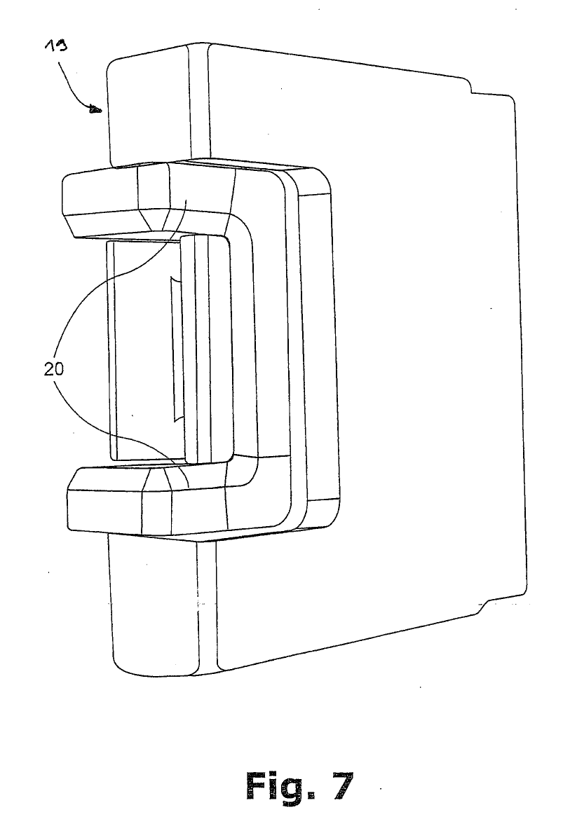

FIG. 7 is a detailed view of the guide for the slide.

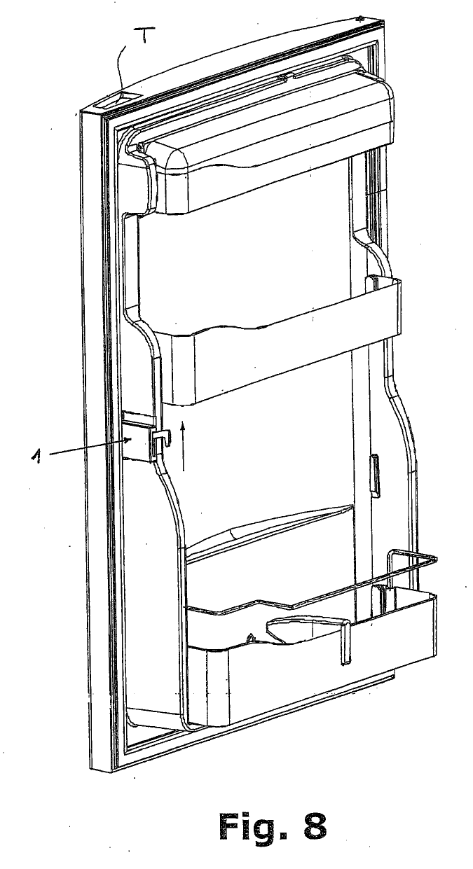

FIG. 8 shows the door of a refrigerator in accordance with the invention.

With reference to the figures and more especially to FIGS. 1 and 3 it will be seen that the bolt housing is quite simple in its design. It comprises two preferably injection molded housing shells 3a and 3b able to be locked together by catch means, which as a rule are manufactured of some suitable plastic. For more expensive designs able to withstand heavy loads (crash-proof applications in mobile homes) metal injection castings also come into question.

The right hand housing shell 3b serves as a bearing and holding part. For this purpose it possesses a bearing pin 4 on which the hook bolt 7 is pivotally mounted. The bearing pin 4 is ideally made longer than is necessary merely for supporting the hook bolt 7. Accordingly it is possible, when the housing is assembled, to cause the bearing pin 7 to fit into a corresponding recess in the left hand housing shell, which is not illustrated in FIG. 3 so that the bearing pin 4 is supported by the left hand L. Although the bearing pin is hollow in order to avoid undesired accumulations of material in the case of injection molding, it will not break off, owing to this feature, even if the hook bolt is subjected to a violent tension force—for example if the refrigerator contents should be slung from the inside against the refrigerator door in the case of abrupt braking or in the case event a traffic accident.

The housing shells 3a and 3b have a well 6 at their top inner side for a helical spring to bear against.

Finally the right hand housing shell 3b has a detent spur 5, which in the mounted condition fits into a corresponding detent opening in the left hand housing shell 3a. This simple detent spur 5 is not able to transmit heavy forces. However it is sufficiently strong to hold the two housing shells 3a and 3b together until fitted to the piece of furniture.

For the purpose of assembly the bolt housing has two or more through openings for assembly screws. They are so made that the assembly screws not only hold the bolt housing on the piece of furniture but also thrust the two housing shells firmly together.

The hook bolt 7 is preferably manufactured of metal, as for example in the form of a part stamped from thick aluminum sheet. The hook-like locking portion 8 has a ramp 9 on its outer side. The ramp thrusts the hook bolt 7 during closing of the refrigerator door upward into a position ready for engagement as soon as the hook bolt strikes the outer edge of the lock striker 20. The hook-like locking portion has on its inner side an oblique portion 10 running in such a direction that the hook bolt 7 does not under load have any tendency to disengage and on the contrary tends to be more and more firmly hooked on the lock striker. Finally the hook bolt has a stud 11 on its top narrow side. This stud 11 serves as a bearing stud. Together with the already mentioned well 6 in the bolt housing it holds a helical spring in the compressed condition.

This helical spring urges the hook bolt 7 toward the engaged position. This takes place in a simple and effective fashion. The helical spring is promptly not only subjected to compression along its principal axis but also to a bending force pivotally in relation to its principal axis, since it is held fast between the bolt housing and the hook bolt.

The hook bolt 7 has its locking portion 8 (which is to engage the striker) projecting on the one side, and on the its other side has its elongated beam-like extension extending out of the bolt housing, see FIG. 3. The function of this beam-like portion will be explained below. In other respects the hook bolt 7 and the spring biasing it are surrounded by the bolt housing consisting of the two housing shells 3a and 3b, or even completely surrounded thereby. Accordingly there is a compact bolt element consisting of only a few parts and therefore economic to manufacture, i. e. a bolt module.

The locking member is in this case designed in the form of a slide 14, this allowing an extremely simple construction.

The support or guidance means of this slide 14 is disposed on the outer side of the bolt housing. For this purpose a respective lug 12a and 12b is molded on each housing shell 3a and 3b near the end side, eventually to face the locking portion, of the bolt housing, such lug representing essentially an extension of the major principal face of the respective housing shell. These lugs 12a and 12b provide lateral guidance for the slide 14, functioning as a locking member, which runs on the outside on the end side of the bolt housing.

At least one of the lugs, in the present case both of them 12a and 12b, bears a further perpendicularly disposed lug 13a and 13b. Owing to this the slide is in portions completely surrounded and slides in section thereof in a channel surrounding it like a belt.

The slide 14 itself basically has the form of a relatively thin elongated rectangular plate, see FIG. 4. In the working embodiment this plate is slotted for about two thirds of its length. The slotted portion constitutes two strip springs 15a and 15b, which at their outer end respectively bear a detent extension 16a and 16b. These detent extensions 16a and 16b each fit in recesses 17a and 17b assigned to them and into the lug 12a and 12b provided for lateral guidance. Accordingly the slide may be held in a first position, in which it restrains the hook bolt in the disengaged position and in a second position, in which it does not restrict the function of the hook bolt. This first position is illustrated in FIG. 1 whereas the second position is depicted in FIG. 2.

FIG. 2 serves to make clear the function of the slide 14. When the slide is in its first upwardly shifted position, the two outer ends of the detent extensions 16a and 16b of the strip springs 15a and 15b simultaneously constitute a support face or respectively an abutment for the hook bolt. This support face supports the hook bolt and prevents the hook bolt from moving down further and into its engaged position. The hook bolt is consequently deactivated.

The reader will also see that the non-slotted portion of the slide 14 is provided with an opening 18, into which if required a pin, a narrow screw driver, the tip of a ball pen or the like may be introduced in order to shift the slide to and fro, see f. i. FIG. 4.

However as a rule the slide 14 can be shifted to and fro without any special tool. For the detent extensions 16a and 16b of its strip springs 15a and 15b and the corresponding detent recesses 17a and 17b in the lugs providing for lateral guidance are so configured that the slide may be readily thrust out of its first position into its second position not obstructing the hook bolt if the hook bolt as such is thrust by hand downward into its position corresponding to the engaged position. The thrust on the hook bolt shifts the slide out of its detent engagement and presses it downward into its second position, where it is caught again. Conversely the slide 14 may also be readily thrust out of its second into its first position. As illustrated in FIG. 1 in its second position it extends past the bottom edge of the hook bolt in a downward direction. Accordingly the slide 14 is readily accessible in order to be thrust upward.

As illustrated in FIGS. 2 and 7 at least the channel consisting of the two lugs 12a and 12b provided for lateral guidance and the third lugs 13a and 13b disposed perpendicularly thereto only constitutes a small fraction, i. e. a portion, which only fits around and covers a limited portion of the slide 14. The major part of the slide 14 therefore remains visible. Thus it is possible at any time, without pondering the matter and intuitively to see the function of the slide. This is more particularly so, when the slide is for example made of plastic with a red coloration and clearly to be distinguished from the white or gray bolt housing.

As already mentioned on its side at its locking portion for engaging the lock striker and on its other side with an elongated, beam-like extension, the hook bolt 7 projects out of the bolt housing. This elongated beam-like extension serves for coupling the unlocking mechanism, which for example consists of a strand and thrusts down against the beam-like extension, preferably without being permanently connected with the latter. The strand is for its part connected with a disengaging knob, which is let into the top edge of the refrigerator door.

FIG. 5 shows the striker element 19. It comprises a housing, which bears the lock striker 20 as such surrounding the opening into which the locking portion 8 of the hook bolt 7 fits. The housing also accommodates the refrigerator lights in the form of a printed circuit board with LEDs to shine into the interior of the refrigerator through a window with a translucent cover

FIG. 6 shows the striker element with the lock striker pulled outward and held by catch means in this position. The lock striker renders it possible to restrain the refrigerator door in a position in which it leaves the door somewhat ajar so that the refrigerator is ventilated and even during long periods of non-use of the refrigerator and/or when the refrigerating space is not completely cleaned no unpleasant odors will be evolved and in fact the refrigerator interior may dry out.

FIG. 7 shows in detail how the slide 14 is supported for its movements, i. e. how the channel is designed whose construction is constituted in part by the right hand housing shell 2b with its lugs 12b and 13b.

FIG. 8 shows the door of a mobile refrigerator designed in accordance with the invention. The knob T on the refrigerator door acts by way of a linkage (not illustrated, within the door) on the beam-like extension B of the hook bolt 7 in order to unlock the hook bolt 7.

Finally it is to be noted that the components above named the left hand and right hand housing shell, may also be termed the first and second housing shell. By the same token this will apply for all components, with reference to which the terms left and right are employed.

### LIST OF REFERENCE NUMERALS

1 bolt element

2 bolt housing

3a first housing shell

3b second housing shell

4 bearing pin

5′ detent spur for locking the housing shells together

6 well for helical spring

7 hook bolt

8 locking portion of the hook bolt

9 outer oblique portion of the hook bolt

10 inner oblique portion of the hook bolt

11 stud for helical spring

12a left hand lateral guide lug

12b right hand lateral guide lug

14 slide

15a left hand strip spring of the slide

15b right hand strip spring of the slide

16a detent extension of the left hand strip spring

16b detent extension of the right hand strip spring

17a detent recesses in the left hand lateral lug

17b detent recesses in the right hand lateral lug

18 opening in the slide

19 striker element

20 moving striker

1. A mobile refrigerator with a refrigerator door held magnetically against the body thereof and an additional automatically engaging hook lock (1 and 19) on closing the refrigerator door and which releases the refrigerator door only following the actuation of an unlocking mechanism, which disengages the hook bolt (7) from the lock striker (20), characterized in that the hook lock (1 and 19) comprises a locking member (14) by means of which the hook bolt (7) may be restrained in a disengaged position so that the refrigerator door is only held closed magnetically.

2. The mobile refrigerator as set forth in claim 1, characterized in that the locking member (14) is able to be so actuated independently of the unlocking mechanism that the hook bolt (7) is set in the disengaged position.

3. A hook lock for a mobile refrigerator as set forth in claim 1, which consists of a striker element (19) and a bolt element (1), the bolt element for its part consisting of a hook bolt (7), which at its one end possesses a hooked locking portion (8) and a bolt housing (3 and, respectively, 2a and 2b), in whose inner space the hook bolt (7) is pivotally mounted and has a window from which the hook-like locking portion (8) protrudes and which has a spring, which thrusts the hook bolt (7) toward its engaged position, characterized in that the hook lock (1 and 19) possesses a locking member (14) able to be operated independently of the unlocking mechanism associated with it, and by means of such locking member the hook bolt (8) may be restrained in the disengaged position, the spring biasing effect being overridden.

4. The hook lock (1 and 19) as set forth in claim 3, characterized in that the locking member (14) is a slide guided for linear motion by the bolt housing(3 and, respectively, 2a and 2b), and which may be thrust into a first position and held therein, in which its restrains the hook bolt (8) in the disengaged position and into a second position, in which it does not restrict the function of the hook bolt.

5. The hook lock (1 and 19) as set forth in claim 4, characterized in that the slide (14) runs on the bolt housing's end side having the window for the passage of the hook-like locking portion, the slide (14) being guided here in a groove (12a, 12b, 13a and 13b) on the outer side of the bolt housing (2).

6. The hook lock (1 and 19) as set forth in claim 5, characterized in that the groove (12a, 12b, 13a and 13b) surrounds the slide only in portions and preferably for less than 50% so that the possible extreme positions of the slide (14) and the function then respectively performed by the slide can be readily perceived from the outside, the slide preferably being of injection molded plastic material which is colored differently to the plastic material of the bolt housing in a conspicuous manner.

7. The hook lock (1 and 19) as set forth in claim 4, characterized in that the position of the slide (14) sets the size of the free opening of the window for the passage of the hook-like locking portion (8).

8. The hook lock (1 and 19) as set forth in claim 4, characterized in that the slide (14) has the basic shape of a plate slotted from its end side whose slotted portion constitutes two strip springs (15a and 15b) each with a detent extension (16)a and 16b ), such detent extension fitting into corresponding recesses (17a and 17b) in the bolt housing (3 and, respectively, 2a and 2b) so that the slide (14) may be releasably held in its disengaged position and preferably also set in a second position releasably in which it does not restrict the function of the hook bolt.

9. The hook lock (1 and 19) as set forth in claim 4, characterized in that the slide (14) has a point of action, preferably in the form of a hole in its non-slotted portion, which may be engaged with the hand or with a tool such as a pin, a ball point pen or the like in order to shift the slide (14), overriding the forces restraining it and overriding the spring biasing action acting toward its engaged position, from one position into the other position.

10. The hook lock (1 and 19) as set forth in claim 4, characterized in that the detent means (16a and 16b, 17a and 1 7b) of the slide in the position in which it restrains the hook bolt (7) in its disengaged position, is such that the slide (14) can be thrust back by manual pressure on the hook bolt (7) toward its engaged position into the position in which it does not restrict the function of the hook bolt.

11. The hook lock (1 and 19) as set forth in claim 4, characterized in that the slide (14), when it is located in its second position, in which it does not restrict the function of the hook bolt (7), overlaps the bottom edge of the bolt housing (3 and, respectively, 2a and 2b) downwardly so that a slide portion extending freely out of the bolt housing is available on which the slide may be thrust away from the bolt housing essentially without restriction upwardly into its first position.

12. The hook lock (1 and 19) as set forth in claim 4, characterized in that the side, facing away from the hook-like locking portion (8), of the hook bolt (7) protrudes from the bolt housing (3 and, respectively, 2a and 2b) and the portion, projecting here from the bolt housing, is designed in the form of a portion for coupling of the unlocking mechanism.

13. The hook lock (1 and 19) as set forth in claim 3, characterized in that the spring is accommodate in the interior of the bolt housing (3 and, respectively, 2a and 2b).

14. The hook lock (1 and 19) as set forth in claim 3, characterized in that the spring is a helical spring, which is held in the bolt housing (3 and, respectively, 2a and 2b) between a stud or a well (6) in the bolt housing and a stud (11) on the hook bolt and is prevented from moving out of position by the bolt housing.

15. The hook lock (1 and 19) as set forth in claim 14, characterized in that the spring is so disposed and so held that it is only regularly loaded by a thrust in the direction of its principal axis but also in addition is loaded to bend it athwart its principal axis.

16. The hook lock (1 and 19) as set forth in claim 4, characterized in that the groove (12a and 12b and 13a and 13b) guiding the slide (14) even after complete assembly of the bolt housing (3 and, respectively, 2a and 2b), as viewed looking toward the slide movement, is so open on one side that the slide may be introduced into the groove from the outside after putting in the hook bolt and the spring and along the following complete assembly of the bolt housing.

17. The hook lock (1 and 19) as set forth in claim 3, characterized in that the bolt housing (3) is made in two parts (2a and 2b) and has access openings for mounting screws for the attachment of the lock on a refrigerator, which are so aligned and designed that the two halves (2a and 2b) of the bolt housing are thrust together by the screw attachment means with a loading force.

18. The hook lock (1 and 19) as set forth in claim 3, characterized in that the striker element is provided with a movable portion serving as an additional striker, which may be releasably connected by catch means in an inserted position in which the hook bolt may so fit into the moving portion that the door may be locked in a position, in which the refrigerator door is left ajar for ventilation of the refrigerating space.

19. The hook lock (1 and 19) as set forth in claim 3, characterized in that the striker element (19) has a light means incorporated in it serving for the illumination of the refrigerator when its door is open.

20. The hook lock (1 and 19) as set forth in claim 3, characterized in that the locking member (14) communicates with a signal producing means which when appropriate time produces a “hook bolt deactivated” warning signal in particular when the driver turns on the ignition of the vehicle, retracts supports or takes other measures indicative of starting a journey.
